(19) United States
(12) Patent Application Publication
(10) Pub. No.: US 2024/0152727 A1
(43) Pub. Date: May 9, 2024

(54) NEURAL NETWORK CONTROLLER

(71) Applicant: Mitsubishi Electric Corporation, Tokyo (JP)

(72) Inventors: Ryoichi TAKASE, Tokyo (JP); Nobuyuki YOSHIKAWA, Tokyo (JP)

(73) Assignee: Mitsubishi Electric Corporation, Tokyo (JP)

(21) Appl. No.: 18/408,668

(22) Filed: Jan. 10, 2024

Related U.S. Application Data
(63) Continuation of application No. PCT/JP2021/030712, filed on Aug. 23, 2021.

(51) Int. Cl. G06N 3/04

(52) U.S. Cl. CPC G06N 3/04

(57) ABSTRACT

A neural network controller according to the present disclosed technology is a multilayer neural network controller having a weight matrix. The weight matrix of the neural network controller is updated on the basis of a loss function that is divided into cases by the gain of the closed loop and that is switched in a mode of presence or absence of a penalty term.

### CROSS REFERENCE TO RELATED APPLICATIONS

This application is a Continuation of PCT international Application No. PCT/JP2021/030712 filed on Aug. 23, 2021, which is hereby expressly incorporated by reference into the present application.

### TECHNICAL FIELD

The present disclosed technology relates to a neural network controller and a learning method for the neural network controller.

### BACKGROUND ART

A neural network means a mathematical model or software for implementing functions and characteristics of a brain with a computer. Since a neural network does not necessarily faithfully reproduce the working of a neural circuit of an actual organism, it may be referred to as an artificial neural network. A neural network is one aspect a learning device, and has been applied to various industrial fields. The artificial intelligence including the artificial neural network is also referred to as artificial intelligence (AI).

In recent years, learning devices and AI represented by neural networks have been attracting more attention due to reports of results by deep learning, reinforcement learning, and the like. For example, in Go, AI is winning against a world level professional player. Whether or not the learning device and the AI attracting attention as described above can he applied to control such as automatic operation of a target such as a robot, a plant, or an unmanned aircraft has started to be studied.

Also in Patent Literature, there is one in which a machine learner is used for a control device of an automatic operation robot (For example, Patent Literature 1). The control device according to Patent Literature 1 infers an operation content or the like using a mathematical model generated by performing reinforcement learning on a machine learner.

### CITATION LIST

### Patent Literature

Patent Literature 1: Japanese Patent No. 6908144 (there is no laid-open application publication)

### SUMMARY OF INVENTION

### Technical Problem

The learning device and the AI include a mechanism for scoring trials called an evaluation function, a loss function, a cost function, or the like. For example, a control device according to Patent Literature 1 uses a negative value of an action value as a loss function, and causes a neural network to learn in such a way as to minimize the loss function. That is, the control device according to Patent Literature 1 causes the neural network to learn in such a way as to increase the action value. According to the specification of Patent Literature 1, the action value indicates how appropriate the operation inferred by the learning model has been. Further, according to the specification of Patent Literature 1, it is designed in such a way that a higher reward is obtained as an absolute value of an error between a command value (a command vehicle speed in the specification) and an actual value (a detection vehicle speed in the specification) is closer to zero.

To paraphrase with an example, a main object of the learning device according to the prior art exemplified in Patent Literature 1 is to imitate a technique of an expert pilot as a teacher. Here, imitation of a teacher and stability of a closed loop when the learning device is used as a control device are different concepts.

As described above, in the conventional learning device, the stability of the closed loop, which is an important characteristic as the control device, is not necessarily considered. The present disclosed technology provides a neural network controller in consideration of closed-loop stability, and a learning method for the neural network controller.

### Solution to Problem

The neural network controller according to the present disclosed technology is a multilayer neural network controller having a weight matrix. The weight matrix of the neural network controller is updated on the basis of a loss function that is divided into cases by the gain of the closed loop and that is switched in a mode of presence or absence of a penalty term.

### Advantageous Effects of Invention

Since the neural network controller according to the present disclosed technology has the above configuration, closed-loop stability is maintained.

### BRIEF DESCRIPTION OF DRAWINGS

FIG. 1 is a schematic diagram illustrating a closed loop using a neural network controller according to a first embodiment.

FIG. 2A is a first hardware configuration diagram of the neural network controller according to the first embodiment. FIG. 2B is a second hardware configuration diagram of the neural network controller according to the first embodiment.

FIG. 3 is a flowchart illustrating processing steps according to a learning method for a neural network controller according to a second embodiment.

### DESCRIPTION OF EMBODIMENTS

The present application is made by claiming the application of the exception provision for the loss of novelty of the invention to the following paper written by the inventor.

“Stability-Certified Reinforcement Learning via Spectral Normalization”, Ryoichi Takase, Nobuyuki Yoshikawa, et al., December 2020, https://arxiv.org/pdf/2012.13744.pdf

Therefore, an academic aspect such as a principle that forms the basis of the present disclosed technology will be clarified by referring to the paper (Hereinafter, this is referred to as “inventor's paper”). In the present specification, description of proof of principle and the like is omitted, and description of academic aspects is minimized.

### First Embodiment

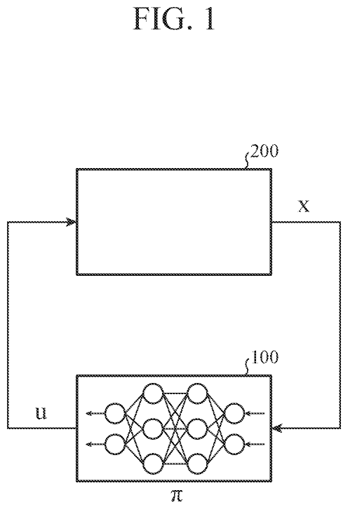

FIG. 1 is a schematic diagram illustrating a closed loop using a neural network controller 100 according to a first embodiment. As illustrated in FIG. 1, the neural network controller 100 forms a closed loop in such a way as to control a control target 200.

It is assumed that the control target 200 illustrated in FIG. 1 is a system that satisfies the following discrete time state equation when linearized at a certain equilibrium point.

x(k+1)=A_{H}x(k)+B_{H}u(k) (1)

Here, a vertical vector x(k) represents the state of the control target 200 in the k-th sampling. A vertical vector u(k) represents an input to the control target 200 in the k-th sampling. Matrices A_{H} and B_{H} are A matrix and B matrix of the discrete time state equation of the control target 200 linearized at the equilibrium point.

In general, in order to distinguish between continuous time and discrete time, there is also a method of using parentheses when representing continuous time and using a subscript when representing discrete time (For example, xₖ₊₁ or the like). In the present specification, in order to avoid abuse of a subscript, a method using parentheses is used even for discrete time as shown in Formula (1).

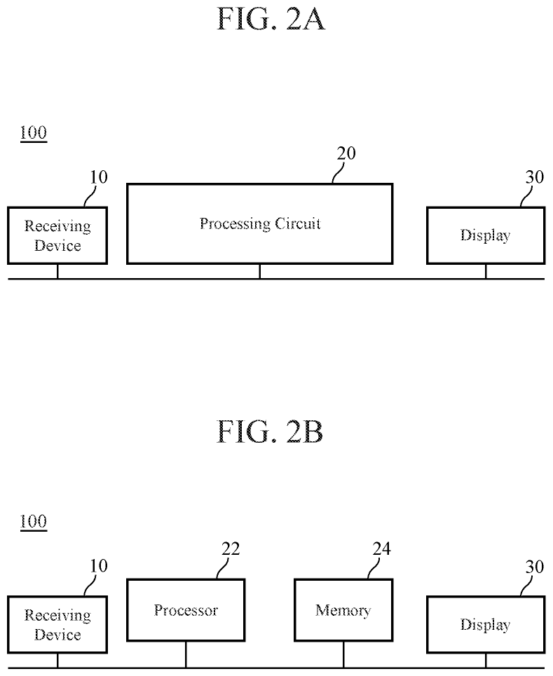

FIG. 2A is a first hardware configuration diagram of the neural network controller 100 according to the first embodiment.

As illustrated in FIG. 2A, the neural network controller 100 according to the first embodiment may be implemented by dedicated hardware. In the case of being configured by dedicated hardware, the neural network controller 100 includes a receiving device 10, a processing circuit 20, and a display 30. It is conceivable that the processing circuit 20 is, for example, a single circuit, a composite circuit, a programmed processor, a parallel programmed processor, an ASIC, a FPGA, or a combination thereof. Each processing content of the neural network controller 100 may be implemented by separate hardware, or may be collectively implemented by a single piece of hardware.

FIG. 2B is a second hardware configuration diagram of the neural network controller 100 according to the first embodiment.

As illustrated in FIG. 2B, the neural network controller 100 according to the first embodiment may be implemented by software. In other words, the neural network controller 100 according to the first embodiment may be implemented by a processor 22 that executes a program stored in a memory 24. The neural network controller 100 illustrated in FIG. 2B includes a receiving device 10, a processor 22, a memory 24, and a display 30. The processor 22 may be implemented by a CPU (also referred to as a central processing unit, a processing unit, an arithmetic unit, a microprocessor, a microcomputer, a processor, or a DSP).

The memory 24 may be, for example, a nonvolatile or volatile semiconductor memory such as a RAM, a ROM, a flash memory, an EPROM, or an EEPROM (registered trademark). In addition, the memory 24 may be implemented by a magnetic disk, a flexible disk, an optical disk, a compact disk, a mini disk, a DVD, or the like.

A part of the neural network controller 100 may be implemented by dedicated hardware, and the other part may be implemented by software or firmware. As described above, each function of the neural network controller 100 is implemented by hardware, software, firmware, or a combination thereof.

The neural network controller 100 illustrated in FIGS. 1 and 2 is a multilayer neural network and is defined by the following formula. That is, u(k), which is an input to the control target 200 expressed by Formula (1), is designed by the following formulae.

w⁰(k)=x(k); (2a)

wⁱ(k)=ϕⁱ(Wⁱwⁱ⁻¹(k)+bⁱ), i=1, 2, . . . , l; (2b)

u(k)=W^{l+1}w^{l}(k)+b^{l+1;} (2c)

Here, wⁱ(k) which is a vertical vector represents an output from the i-th layer in the neural network. Wⁱ(k) is a weight matrix used in the i-th layer in the neural network, and weights the output of the (i−1)-th layer. In addition, bⁱ(k) represents a bias of the i-th layer in the neural network. The neural network represented by Formula (2) is a multilayer neural network including l (L) layers in total.

φⁱ( ) shown in Formula (2b) is a vertical vector including an activation function and is given by the following formula.

ϕ^{l}(v):=[φ(v₁), φ(v₂), . . . , φ(vₙ_{ᵢ})]^{T} (3)

Here, T of the upper subscript on the right side of Formula (3) represents a transposition operation. In addition, each element in the right side of Formula (3) is an activation function.

The situation that the closed loop shown in FIG. 1 is stable in an equilibrium state is expressed by the following formulae.

x [symbol] = [symbol] + [symbol] (4a)

u [symbol] =π(x [symbol] ) (4b)

Here, π( ) in the right side of Formula (4b) is a function representing the input/output relationship of the neural network controller 100 illustrated in Formulae (2a) to (2c).

When an argument of φ( ) in the right side of Formula (2b) is set to v*, Formulae (4a) to (4b) can be expressed as an extended system as follows.

$${x}_{\text{?}} = {A}_{H} {x}_{\text{?}} + {B}_{H} {u}_{\text{?}} \qquad ( 5 a )$$

$$[ \begin{matrix}{u}_{\text{?}} \\ {v}_{\text{?}}\end{matrix} ] = N [ \begin{matrix}{x}_{\text{?}} \\ {w}_{\text{?}} \\ 1\end{matrix} ] \qquad ( 5 b )$$

$${w}_{\text{?}} = ϕ ( {v}_{\text{?}} ) \qquad ( 5 c )$$

$$\text{?} \text{indicates text missing or illegible when filed}$$

Note that N of the matrix in Formula (5b) is defined by the following formula.

$$N := [ \begin{matrix}0 & 0 & 0 & … & {W}^{l + 1} & {b}^{l + 1} \\ {W}^{1} & 0 & … & 0 & 0 & {b}^{1} \\ 0 & {W}^{2} & … & 0 & 0 & {b}^{2} \\ ⋮ & ⋮ & ⋱ & ⋮ & ⋮ & ⋮ \\ 0 & 0 & … & {W}^{l} & 0 & {b}^{l}\end{matrix} ] = : [ \begin{matrix}{N}_{ux} & {N}_{uw} & {N}_{ub} \\ {N}_{υ x} & {N}_{υ w} & {N}_{υ b}\end{matrix} ] \qquad ( 6 )$$

The present disclosed technology is based on a strategy of updating weights of a neural network by using a solution matrix of a linear matrix inequality (Linear Matrix Inequality, hereinafter referred to as “LMI”) shown below. Several matrices are defined to indicate the LMIs to be solved.

$${R}_{V} := [ \begin{matrix}I & 0 \\ {N}_{ux} & {N}_{uw}\end{matrix} ] \qquad ( 7 )$$

$${R}_{ϕ} := [ \begin{matrix}{N}_{υ x} & {N}_{υ w} \\ 0 & 1\end{matrix} ] \qquad ( 8 )$$

$${Ψ}_{ϕ} := [ \begin{matrix}diag ( {β}_{ϕ} ) & - I \\ - diag ( {α}_{ϕ} ) & I\end{matrix} ] \qquad ( 9 )$$

$${M}_{ϕ} ( λ ) := [ \begin{matrix}0 & diag ( λ ) \\ diag ( λ ) & 0\end{matrix} ] \qquad ( 10 )$$

Note that λ in Formula (10) is λ≥0.

The LMI to be solved necessary for updating the weight matrix is given by the following formulae.

$${R}_{V}^{T} [ \begin{matrix}{A}_{H}^{T} {PA}_{H} - P & {A}_{H}^{T} PB \\ {B}^{T} {PA}_{H} & {B}^{T} PB\end{matrix} ] {R}_{V} + {R}_{ϕ}^{T} {Ψ}_{ϕ}^{T} {M}_{ϕ} ( λ ) {Ψ}_{ϕ} {R}_{ϕ} ≺ 0 \qquad ( 11 )$$

$$\begin{matrix}[ \begin{matrix}( {\overline{υ}}_{i}^{1} - {υ}_{* , i}^{1} & {W}_{i}^{1} \\ {W}_{i}^{1 T} & P\end{matrix} ] ⪰ 0 , & i = 1 , …\end{matrix} , {n}_{1} \qquad ( 12 )$$

Here, W¹ in Formula (12) is a weight matrix including weight parameters of the first layer of hidden layers. In addition, v¹ is given by v¹=W¹x. Furthermore, a bar above v¹ indicates an upper bound of v¹. Note that, in order to emphasize that the inequality signs in Formulae (11) and (12) are matrix inequalities, curved signs different from normal inequalities for comparing sizes of scalars are used.

If there is a positive definite symmetric matrix P satisfying Formulae (11) and (12), then the closed loop shown in FIG. 1 is locally stable in the equilibrium state (x*). The conditions of the LMIs shown in Formulae (11) and (12) may be referred to as a Lyapunov Condition.

If P, which is the solution matrix of the LMIs shown in Formulae (11) and (12), can be found, it is possible to obtain a region of attraction (ROA) of the closed loop shown in FIG. 1, that is, information on a stabilizable region. It has been proved that the following n-dimensional ellipses that can be specifically defined by P of the solution matrix are necessarily included in ROA.

ε(P, x*):={x∈ [symbol] :(x−x*)^{T}(x−x*)<1} (13)

The form as shown in Formula (13) is referred to as a quadratic form. Note that Formula (13) represents an ellipse when the state (x) is two-dimensional, and represents an ellipsoid when the state (x) is three-dimensional. In general, since the state (x) is n-dimensional, the region defined by Formula (13) is not strictly only an ellipse. The region defined by Formula (13) will be referred to as an “n-dimensional ellipse” here.

In general, the Small Gain theorem is known as a theorem regarding the stability of the closed loop. It is derived from the Small Gain theorem that, in short, the gain of the neural network controller 100 is suppressed in order that there is P of the positive definite symmetric matrix satisfying Formulae (11) and (12). Therefore, the present disclosed technology first attempts to normalize the weight matrix of the hidden layer of the neural network controller 100 with a certain value. This method is described in the inventor's paper as Pre-Guaranteed RL (Reinforcement Learning).

In Pre-Guaranteed RL, the normalized weight matrix is given by the following formula.

$$\begin{matrix}{\hat{W}}^{i} = \frac{{δ}^{i}}{{σ}_{max} ( {W}^{i} )} {W}^{i} , & {δ}^{i} > 0 , & i = 1 , 2 , … , l\end{matrix} \qquad ( 14 )$$

Note that Wⁱ with a hat in the left side of Formula (14) represents a normalized weight matrix in the i-th layer. In addition, δⁱ is a tuning parameter defined for the i-th layer and is a positive constant. Further, σₘₐₓ( ) of the function in the denominator in the right side of Formula (14) represents the maximum singular value. Note that the maximum singular value is equivalent to an induced norm shown below.

$${σ}_{max} ( W ) = {sup}_{h \neq 0} \frac{{‖ W h ‖}_{2}}{{‖ h ‖}_{2}} \qquad ( 15 )$$

That is, Pre-Guaranteed RL normalizes the weight matrix with its maximum singular value, as shown in Formula (14). Such normalization is also referred to as spectral normalization.

Deforming Formula (14) indicates that the above tuning parameter is equal to the spectrum norm of the normalized weight matrix.

$$\begin{matrix}{σ}_{max} ( {\hat{W}}^{i} ) = \frac{{δ}^{i}}{{σ}_{max} ( {W}^{i} )} {σ}_{max} ( {W}^{i} ) \\ = {δ}^{i}\end{matrix} \qquad ( 16 )$$

Formula (15) has the same form as the H-infinity norm in the linear system or the L2 gain in the nonlinear system in terms of being defined by the induced norm. The L2 gain of the nonlinear system (H) that performs mapping from an input signal x to an output signal y is given by the following formula.

$${γ}_{H} := {‖ H ‖}_{L 2} = {sup}_{x} \frac{{‖ y ‖}_{L 2}}{{‖ x ‖}_{L 2}} \qquad ( 17 )$$

$$wherein$$

$${‖ x ‖}_{L 2} = \sqrt{{\int }_{0}^{∞} {\vert x ( t ) \vert}^{2} dt}$$

$${‖ y ‖}_{L 2} = \sqrt{{\int }_{0}^{∞} {\vert y ( t ) \vert}^{2} dt}$$

Although details are described in the inventor's paper, the relationship between the L2 gain and the spectrum norm that can be defined for the neural network controller 100 is expressed by the following formula.

$${γ}_{π} < {\prod }_{i = 1}^{l + 1} {δ}_{i} = : {\overline{σ}}_{i} \qquad ( 18 )$$

Note that π of the subscript in the left side of Formula (18) represents the neural network controller 100 that is the nonlinear system illustrated in FIG. 1.

Therefore, the condition that the closed loop illustrated in FIG. 1 is stable with the finite gain L2 is expressed as follows on the basis of the Small Gain theorem.

σ̅_̅{̅π̅}̅γ_{H}<1 (19)

Note that a subscript π in the left side of Formula (19) represents the neural network controller 100, and a subscript H represents the control target 200.

Considering the neural network controller 100 as being divided into L hidden layers and a final layer behind the hidden layers, Formula (19) can be modified as follows.

$$\{ {σ}_{max} ( {W}^{L + 1} ) {\prod }_{i = 1}^{L} {δ}_{i} \} {γ}_{H} < 1 \qquad ( 20 )$$

Formula (20) can be further modified as follows by focusing on the final layer.

$${σ}_{max} ( {W}^{L + 1} ) < \frac{1}{\{ {\prod }_{i = 1}^{l} {δ}_{i} \} {γ}_{H}} , wherein \{ {\prod }_{i = 1}^{l} {δ}_{i} \} {γ}_{H} > 0 , \qquad ( 21 )$$

That is, Formula (21) suggests that the closed loop can be stabilized with the finite gain L2 if the maximum singular value of the weight matrix of the final layer is suppressed to be smaller than the right side of the inequality.

As described above, the Pre-Guaranteed RL described in the first embodiment performs spectral normalization for normalizing the weight matrix with the maximum singular value thereof, and keeps the closed loop stable with the finite gain L2. The normalization of the weight matrix with the maximum singular value can be achieved by providing a penalty term in the loss function in learning. The loss function used in machine learning may be referred to as an evaluation function, a cost function, or an objective function. In short, the loss function is an index indicating how well the learning is performed toward the purpose. Like other optimization problems, learning results in a problem of obtaining a parameter that minimizes this loss function. It is assumed that a main loss function representing a purpose of learning given to the neural network controller 100 is represented by Vₘₐᵢₙ( ). In Pre-Guaranteed RL described in the first embodiment, it is conceivable that V(W) of a function described below is a loss function.

$$V ( W ) = \{ \begin{matrix}{V}_{main} ( W ) & if \overline{{σ}_{π}} {γ}_{H} < 1 \\ {V}_{main} ( W ) + {V}_{P} ( {γ}_{W} ) & if \overline{{σ}_{π}} {γ}_{H} \geq 1\end{matrix} \qquad ( 22 )$$

Here, V_{P}( ) is a penalty term. Formula (22) indicates that the present disclosed technology divides the loss function into cases by the L2 gain of the closed loop, and switches the loss function in a mode of presence or absence of a penalty term. The penalty term may be a function using the L2 gain of the weight matrix as an argument.

Meanwhile, in the technical field of learning, a regularization term is also added to the main loss function in order to suppress over-learning. This technique is performed in ridge regression. This is performed for the purpose of suppressing over-learning, and is distinguished from the purpose of stably maintaining the closed loop of the present disclosed technology. As described above, the loss function according to the first embodiment expressed by Formula (22) is divided into cases by the gain of the closed loop. The technique of adding a regularization term to the main loss function in the ridge regression does not have a technical feature regarding the loss function of the neural network controller 100 according to the first embodiment, that “the loss function is switched by the gain of the closed loop”.

A learning device according to the prior art, adding an L2 regularization term to a main loss function for a purpose other than suppressing over-learning is also disclosed. For example, Japanese Patent Application Laid-Open No. 2020-8993 discloses a technique of adding an L2 regularization term to a loss function for the purpose of reducing the size of a neural network while suppressing a decrease in accuracy. The prior art exemplified in this patent literature also does not have a technical feature regarding the loss function of the neural network controller 100 according to the first embodiment of “switching the loss function by the gain of the closed loop”.

As described above, since the neural network controller 100 according to the first embodiment has the above configuration, the closed loop is stably maintained the finite gain L2.

### Second Embodiment

The neural network controller 100 according to the first embodiment has an effect of maintaining the closed loop stable with the finite gain L2 by devising how to update the weight matrix. A neural network controller 100 according to a second embodiment has an effect of capable of designing an ROA of the closed loop, that is, a stabilizable region.

In the second embodiment, the same reference numerals as those in the first embodiment are used unless otherwise distinguished. In addition, in the second embodiment, the description overlapping with the first embodiment is appropriately omitted.

In the neural network controller 100, if P of the positive definite symmetric matrix satisfying the LMIs shown in Formulae (11) and (12) is found, the closed loop shown in FIG. 1 is locally stable in the equilibrium state (x*). In addition, the ROA of the closed loop at that time includes an n-dimensional ellipse defined by Formula (13) using P.

Therefore, the neural network controller 100 according to the second embodiment employs a procedure of determining an n-dimensional ellipse included in the ROA to be designed first. Candidates of the positive definite symmetric matrix (P) defining the n-dimensional ellipse are determined as follows.

P:=Q^{T}Q (23)

Here, T of the upper subscript in the right side of Formula (23) represents a transposition operation. Q in the right side of Formula (23) may be, for example, a primary transformation matrix.

The eigenvalues and the eigenvectors of the primary transformation matrix (Q) satisfy the following formulae.

$$\begin{matrix}{λ}_{1} {x}_{1} = {Qx}_{1} , & {x}_{1} \neq 0 \\ {λ}_{2} {x}_{2} = {Qx}_{2} , & {x}_{2} \neq 0 \\ ⋮ & ⋮ \\ {λ}_{n} {x}_{n} = {Qx}_{n} , & {x}_{n} \neq 0\end{matrix} \qquad ( 24 )$$

Here, λ satisfying Formula (24) represents an eigenvalue, and x represents an eigenvector. Although there are as many combinations of eigenvalues and eigenvectors as there are as degrees of the state in principle, there are infinite choices of eigenvectors. For example, when an eigenvector corresponding to λ₁ is x₁, kx₁ that is a vector multiplied by k is also an eigenvector. Formula (24) can be further transformed into the following matrix representation.

$$\begin{matrix}{\overbrace{[ \begin{matrix} \\ \begin{matrix}{x}_{1} & {x}_{2} & … & {x}_{n}\end{matrix} \\ \end{matrix} ]}}^{T} [ \begin{matrix}{λ}_{1} & 0 & … & 0 \\ 0 & {λ}_{2} & & ⋮ \\ ⋮ & & ⋱ & 0 \\ 0 & … & 0 & {λ}_{n}\end{matrix} ] = Q {\overbrace{[ \begin{matrix} \\ \begin{matrix}{x}_{1} & {x}_{2} & … & {x}_{n}\end{matrix} \\ \end{matrix} ]}}^{T} \\ ↓ \\ Q = T diag \{ {λ}_{1} , {λ}_{2} , … , {λ}_{n} \} {T}^{- 1}\end{matrix} \qquad ( 25 )$$

If there is an inverse matrix (T⁻¹) of a matrix (T) including eigenvectors, the primary transformation matrix (Q) can be diagonalized into a matrix having eigenvalues as diagonal components.

When the state at the boundary of the n-dimensional ellipse expressed by Formula (13) matches the direction of the eigenvector of the primary transformation matrix (Q), a formula representing the boundary of the n-dimensional ellipse can be transformed as follows.

$$\begin{matrix}{\overbrace{\begin{matrix}( {x}_{{i}_{1}} & {x}_{{i}_{2}} )\end{matrix}}}^{{x}_{i}^{T}} P {\overbrace{( \begin{matrix}{x}_{{i}_{1}} \\ {x}_{{i}_{2}}\end{matrix} )}}^{{x}_{i}} = 1 , for i = 1 , 2 , … , n \\ ↓ \\ {x}_{{i}_{1}}^{2} + {x}_{{i}_{2}}^{2} = \frac{1}{{λ}_{i}^{2}} , for i = 1 , 2 , … , n\end{matrix} \qquad ( 26 )$$

Here, in Formula (26), the state (x) is set to be two-dimensional for simplicity. Further, the equilibrium state (x*) is set as the origin. When the state matches the direction of the eigenvector of the primary transformation matrix (Q), Formula (26) indicates that there is a boundary of an n-dimensional ellipse on a circle whose radius is the reciprocal of the absolute value of the eigenvalue. In other words, it can be said that the eigenvector of the primary transformation matrix (Q) is related to the direction of the axis of the n-dimensional ellipse, and the eigenvalue is related to the length of the axis of the n-dimensional ellipse.

As described above, the neural network controller 100 according to the second embodiment determines the primary transformation matrix (Q) that determines the n-dimensional ellipse included in the ROA to be designed first. Next, from the obtained primary transformation matrix (Q), a positive definite symmetric matrix (P) is calculated using Formula (23). Next, it is confirmed whether or not the positive definite symmetric matrix (P) satisfies the LMIs expressed by Formulae (11) and (12).

In general, there is a tendency that the ROA can be increased by decreasing the gain of the closed loop. Therefore, for example, it is conceivable to change the loss function as follows using the weight matrix of the neural network controller 100 obtained in the first embodiment as an initial value.

$${V}_{2} ( W ) = \{ \begin{matrix}{V}_{main} ( W ) & if \overline{{σ}_{π}} {γ}_{H} < {γ}_{2} \\ {V}_{main} ( W ) + {V}_{P} ( {γ}_{W} ) & if \overline{{σ}_{π}} {γ}_{H} \geq {γ}_{2}\end{matrix} \qquad ( 27 )$$

Here, γ₂ appearing in the condition of Formula (27) is a positive number smaller than one. Note that the initial value of the weight matrix is not limited to the value obtained in the first embodiment, and a weight matrix having a small gain may be used as the initial value. In a method of solving the optimization problem repeatedly by appropriately changing γ₂ appearing in the condition of Formula (27), Gamma Iteration in the H-infinity control theory is used as a reference.

In recent years, it is possible to easily obtain a numerical solution of LMI by numerical analysis software. Therefore, it is also conceivable to update the weight matrix of the neural network controller 100 by comparing the obtained solution matrix of the LMI with the positive definite symmetric matrix (P) derived from the ROA to be designed first. For example, if the solution matrix of the LMI obtained when the weight matrix of the neural network controller 100 is slightly changed in a certain direction approaches the designed positive definite symmetric matrix (P), the weight matrix may be updated in that direction. In other words, this method numerically performs a gradient method. As described above, the neural network controller 100 according to the present disclosed technology may numerically perform the gradient method to update the weight matrix of the neural network controller 100.

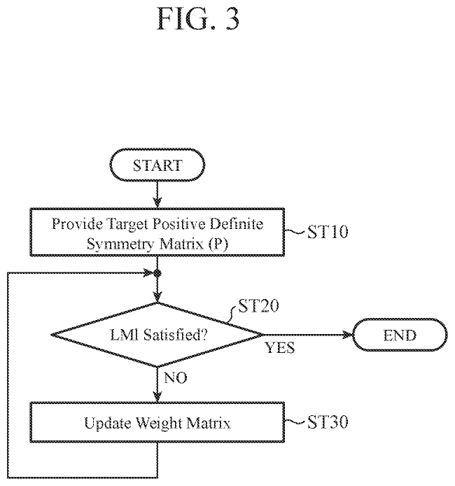

FIG. 3 is a flowchart illustrating processing steps according to the learning method for the neural network controller 100 according to the second embodiment described above. As illustrated in FIG. 3, the processing steps include step ST10 of providing a target positive definite symmetry matrix (P), step ST20 of determining whether or not the LMIs expressed by the formulae (11) and (12) are satisfied, and step ST30 of updating the weight matrix in a case where the LMIs are not satisfied.

As described above, since the neural network controller 100 according to the second embodiment has the above-described configuration, in addition to the effects described in the first embodiment, an effect of capable of designing an ROA of the closed loop, that is, a stabilizable region is obtained.

### INDUSTRIAL APPLICABILITY

The neural network controller 100 according to the present disclosed technology can be applied to control such as automatic operation of a target such as a robot, a plant, or an unmanned aircraft, and has industrial applicability.

### REFERENCE SIGNS LIST

10: receiving device, 20: processing circuit, 22: processor, 24: memory, 30: display, 100: neural network controller, 200: control target

1. A neural network controller which is a multilayer neural network controller having a weight matrix,
wherein the weight matrix is updated on a basis of a loss function that is divided into cases by a gain of a closed loop and that is switched in a mode of presence or absence of a penalty term.

2. The neural network controller according to claim 1,
wherein the penalty term is a function using an L2 gain of the weight metrix as an argument.

3. The neural network controller according to claim 1,
wherein a control target is any one of a robot, a plant, and an unmanned aircraft.
